(19) United States
(12) Patent Application Publication
(10) Pub. No.: US 2007/0248076 A1
(43) Pub. Date: Oct. 25, 2007

(54) METHOD AND SYSTEM FOR IMPROVING FRAME SYNCHRONIZATION, CHANNEL ESTIMATION AND ACCESS IN WIRELESS COMMUNICATION NETWORKS

(75) Inventors: Baowei Ji, Plano, TX (US); Yinong Ding, Plano, TX (US); David Mazzarese, Suwon-si (KR)

Correspondence Address: FOGG & POWERS LLC, 10 SOUTH FIFTH STREET, SUITE 1000, MINNEAPOLIS, MN, 55402, US

(73) Assignee: SAMSUNG ELECTRONICS CO., LTD., Suwon-city (KR)

(21) Appl. No.: 11/736,158

(22) Filed: Apr. 17, 2007

Related U.S. Application Data
(60) Provisional application No. 60/798,861, filed on May 9, 2006.
(60) Provisional application No. 60/794,224, filed on Apr. 21, 2006.

(51) Int. Cl. H04J 3/06

(52) U.S. Cl. 370/350

(57) ABSTRACT

A method and system for improving frame synchronization, channel estimation and access in a wireless network are disclosed. As one example, a method for improving frame synchronization and channel estimation in a wireless network is disclosed. The method includes the steps of generating a first preamble for a frame, generating a false control message for the frame, and scheduling a quiet interval for the frame.

### CROSS-REFERENCE TO RELATED APPLICATIONS AND CLAIM FOR PRIORITY

The present application is related to U.S. Provisional Patent Application No. 60/794,224, entitled “UNINTERRUPTED FRAME SYNCHRONIZATION AND CHANNEL ESTIMATION DURING QUIET FRAMES,” filed on Apr. 21, 2006, and U.S. Provisional Patent Application No. 60/798,861, entitled “SMOOTH COMMUNICATION IN COGNITIVE RADIO (CR) SYSTEMS,” filed on May 9,2006, which are assigned to the assignee of the present application. The subject matter disclosed in U.S. Provisional Patent Application No. 60/794,224 and U.S. Provisional Patent Application No. 60/798,861 is incorporated by reference into the present application as if fully set forth herein. The present application hereby claims priority, under 35 U.S.C. §119(e), to U.S. Provisional Patent Application No. 60/794,224 and U.S. Provisional Patent Application No. 60/798,861.

### FIELD OF THE INVENTION

The invention relates to the telecommunications field, and more particularly, but not exclusively, to a method and system for improving frame synchronization, channel estimation and access in wireless communication networks.

### BACKGROUND OF THE INVENTION

The primary goal of the IEEE 802.22 Working Group on Wireless Regional Area Networks (WRANs) is to develop a standard for a CR-based Physical Layer/Medium Access Control (PHY/MAC) air interface for use by license-exempt wireless communication devices on a non-interfering basis in a frequency spectrum allocated to the television broadcast services. Specifically, the IEEE 802.22 Working Group is tasked to develop the specifications for a fixed point-to-multipoint WRAN that will utilize specific television channels and guard bands for communications in the UHF and VHF television bands.

One of the challenges in designing CR-based systems is determining how to sense the in-band channel (i.e., the channel currently being used by the CR system). An existing method for sensing the in-band channel is to interrupt the signal being transmitted, and periodically and/or opportunistically schedule quiet frames/periods so the in-band channel can be sensed. For example, in a CR-based network, a quiet frame or period can be scheduled as a listening period, in order for the network to determine if a frequency channel in the television spectrum is being used. A quiet period can be shorter than a frame or made up of multiple frames. However, a significant problem with this method is that no preambles or other controlling signals are transmitted during the quiet frames. Consequently, the existing method of sensing channels using quiet frames creates a significant gap between the preceding and succeeding frames. This gap disrupts the frame synchronization and channel estimation processes of the users' receivers, and is particularly undesirable for users experiencing sudden changes in the channels, such as significant channel fading. Also, this gap decreases the CR-based network's ability to utilize the television spectrum efficiently.

For example, the gaps created by quiet frames reduce the accuracy of the frame synchronization process for the user devices involved. Specifically, the preambles in frames are designed to provide a tradeoff between spectral utilization and the accuracy of the frame detection and synchronization processes. In other words, frame timing (synchronization) is a crucial factor in modem design. A certain probability of missed detections and coarse synchronization may be acceptable when a user device is powered on and during initialization and registration with the network. In the sequel, quiet frames and quiet periods are used interchangeably. However, standard receivers are designed to expect periodic preamble transmissions after power on, and a high degree of frame detection and synchronization accuracy is achieved by receivers utilizing this transmission periodicity. One of the key considerations in designing frame synchronization schemes is the periodic availability of the preambles in the frames. A preamble missed during a quiet frame interrupts the continuity of the transmissions, destroys the preamble periodicity, and thus reduces the accuracy of the frame synchronization process for the receiver involved. As such, the updating gap results in a significantly larger frame synchronization error residual.

Also, the gaps created by quiet frames reduce the accuracy of the channel estimation process for the user devices involved. Specifically, the more accurate the channel estimation process of a receiver is, the better its data detection performance will be. Standard receivers improve their channel estimation accuracy by interpolating, accumulating, and/or averaging the preceding and/or succeeding channel estimates of the coherent frames. A preamble missed during a quiet frame interrupts these interpolation, accumulation, and averaging processes, and thus reduces the accuracy of the channel estimation process for the receiver involved.

For example, whether or not a preamble is included with a quiet frame, there are no pilot signals broadcast from the base station (BS) after the downlink (DL) bursts in a frame that includes uplink (UL) bursts, a transmit-to-receive transition gap (TTG), and receiver-to-transmit transition gap (RTG). These signals can occupy up to half of the frame's length. Using a 20 ms long frame as an example, after a quiet frame that does or does not include a regular preamble, the clock will be free-running for 30 ms instead of 20 ms. In a system designed in accordance with the IEEE 802.16d/e standard, the clock is required to be no more than ±2 ppm. However, consider how much a 4 ppm clock can drift in a 2048-point Fast Fourier Transform (FFT) Orthogonal Frequency Division Multiple Access (OFDMA) system. During one symbol, the clock drifts 4*10−6*2*1024/100=0.8% of the sample period. One symbol equals about ⅓ millisecond (ms) (i.e., 2K/6 MHz). During a 30 ms interval, the clock drifts 72% of the sample period. This amount of clock drift is too high.

Furthermore, the gaps created by quiet frames interrupt the statistics accumulation processes of the receivers involved. Many receivers are designed to take advantage of the statistical results of usable, historical channel conditions. A preamble missed during a quiet frame disrupts and degrades this statistics accumulation/collection process. Therefore, a pressing need exists for a methodology that can provide uninterrupted frame synchronization and channel estimation for receivers during quiet frames.

Additionally, the gaps created by quiet frames or quiet periods create significant problems with maintaining and/or recovering synchronization in the wireless networks involved. For example, in wireless networks operating in accordance with the IEEE 802.22 (e.g., CR-based networks) and 802.16 standards, channel access is controlled by a BS that continuously initiates and transmits one frame after another. For normal operations, the BS only needs to include a regular preamble (e.g., one OFDMA symbol using a long training sequence) in a frame. However, the BS needs to include an extra (a.k.a., extended) preamble (e.g., an extra OFDMA symbol using a short training sequence) besides the regular preamble in a frame in order to initiate communications (and synchronization) with a subscriber device, a.k.a., Customer Premises Equipment (CPE), or for recovering synchronization after a long-term interruption. Consequently, the gaps created by quiet frames or periods disrupt the continuity of the frame transmissions, and thus degrade the network's ability to maintain and/or recover synchronization for channel access or communication purposes. Also, after a relatively long quiet period, a user may receive a preamble in a frame, but the preamble may be out of date at that point in time. Consequently, the user will be unable to decode the information in the frame. Therefore, a pressing need exists for a methodology that can be used in wireless networks to maintain and/or recover synchronization after a gap caused by a quiet frame or relatively long quiet period.

### SUMMARY OF THE INVENTION

In a first example embodiment, a method for improving frame synchronization and channel estimation in a wireless network is provided. The method includes the steps of generating a first preamble for a frame, generating a false control message for the frame, and scheduling a quiet interval for the frame.

In a second example embodiment, a method for improving frame synchronization and channel estimation in a wireless network is provided. The method includes the steps of generating a superframe, inserting at least one frame in the superframe, inserting a second frame in the superframe, the second frame including a preamble, a dummy broadcast message, and a quiet interval, and transmitting the superframe.

In a third example embodiment, a method for maintaining or recovering synchronization in a wireless network is provided. The method includes the steps of generating a first frame, determining if the first frame is a quiet frame, if the first frame is a quiet frame, inserting an extended preamble in a second frame, and transmitting the second frame two symbols prior to the end of the first frame.

In a fourth example embodiment, a method for maintaining or recovering synchronization in a wireless network is provided. The method includes the steps of determining if a quiet transmission period is occurring, and if a quiet transmission period is occurring, generating a frame, inserting an extended preamble in the frame, and transmitting the frame.

In a fifth example embodiment, a system for improving frame synchronization and channel estimation in a wireless network is provided. The system includes a base station, and at least one user transceiver coupled to the base station by a radio air interface. The base station is configured to generate a first preamble for a frame, generate a false control message for the frame; and schedule a quiet interval for the frame.

In a sixth example embodiment, a system for improving frame synchronization and channel estimation in a wireless network is provided. The system includes a base station, and at least one user transceiver coupled to the base station by a radio air interface. The base station is configured to generate a superframe, insert at least one frame in the superframe, insert a second frame in the superframe, the second frame including a preamble, a dummy broadcast message, and a quiet interval, and transmit the superframe.

In a seventh example embodiment, a system for maintaining or recovering synchronization in a wireless network is provided. The system includes a base station, and at least one user transceiver coupled to the base station by a radio air interface. The base station is configured to generate a first frame, determine if the first frame is a quiet frame, if the first frame is a quiet frame, insert an extended preamble in a second frame, and transmit the second frame two symbols prior to the end of the first frame.

In an eighth example embodiment, a system for maintaining or recovering synchronization in a wireless network is provided. The system includes a base station, and at least one user transceiver coupled to the base station by a radio air interface. The base station is configured to determine if a quiet transmission period is occurring, and if a quiet transmission period is occurring, generate a frame, insert an extended preamble in the frame, and transmit the frame.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial diagram depicting a system for improving frame synchronization and channel estimation in wireless networks, which can be used to implement a first example embodiment of the present invention;

FIGS. 2A, 2B and 2C are related pictorial diagrams depicting a plurality of frame structures that can be used for improving frame synchronization and channel estimation in wireless networks, in accordance with one or more example embodiments of the present invention; and

FIGS. 3A through 3D are related pictorial diagrams depicting a plurality of frame structures that can be used for maintaining and/or recovering synchronization after a quiet frame or quiet period in a wireless network, in accordance with one or more example embodiments of the present invention.

### DETAILED DESCRIPTION OF PREFERRED EMBODIMENT

In one example embodiment of the present invention, a method is provided that enables receivers in wireless networks to perform frame synchronization and channel estimation without interruption during quiet frames or other quiet periods. As such, the method provides increased flexibility with respect to the network's ability to inform user devices about whether or not a current frame is quiet. Consequently, the method simplifies the design of the control messaging processes in the wireless networks involved, and reduces the overhead associated with the control messages used.

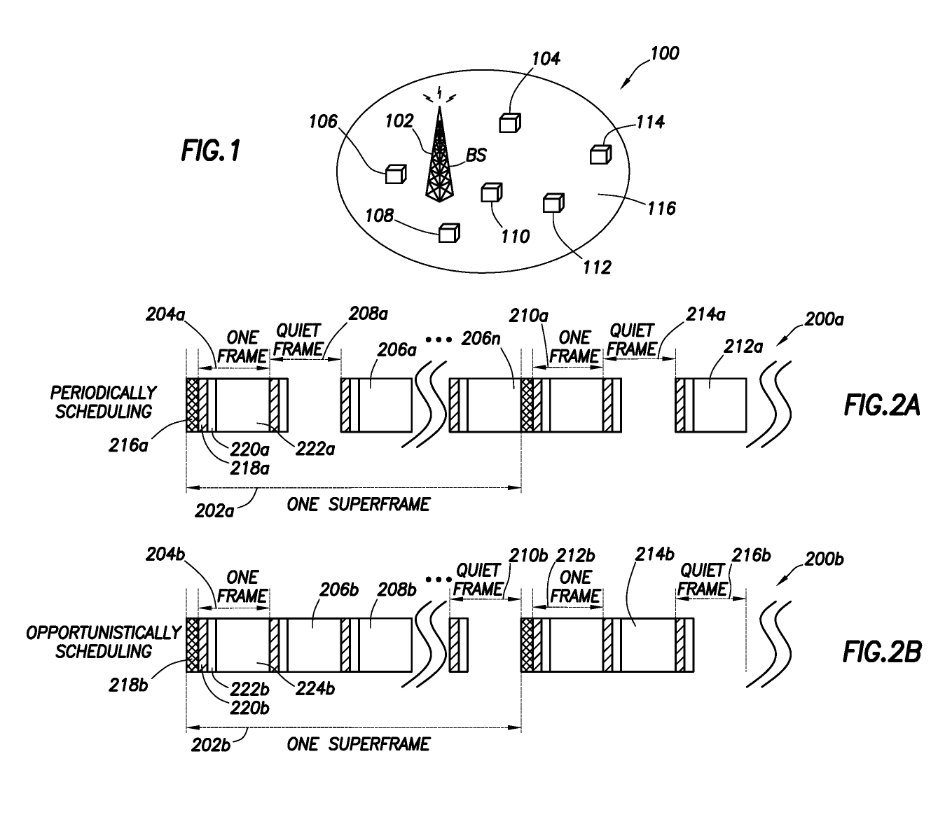

With reference now to the figures, FIG. 1 is a pictorial diagram depicting a system 100 for improving frame synchronization and channel estimation in wireless networks, which can be used to implement a first example embodiment of the present invention. For this example embodiment, and for illustrative purposes only, system 100 is used to implement improved frame synchronization and channel estimation in a CR-based network. However, note that the present invention is not intended to be so limited, and it should be understood that system 100 can be used to implement improved frame synchronization and channel estimation in any suitable wireless network where frames, quiet frames and/or quiet periods are being used.

For this example embodiment, system 100 includes a BS 102, and a plurality of CPE units 104 through 114. In a different embodiment, BS 102 may be implemented as a Base Transceiver Station (BTS) or other suitable network control unit. Similarly, in a different embodiment, CPE units 104 through 114 may be implemented as Mobile Stations (MSs), Active Terminals (ATs), Mobile Terminals (MTs), mobile transceivers, or other suitable wireless devices. In any event, the radio coverage area of BS 102 is indicated generally by the ellipse 116.

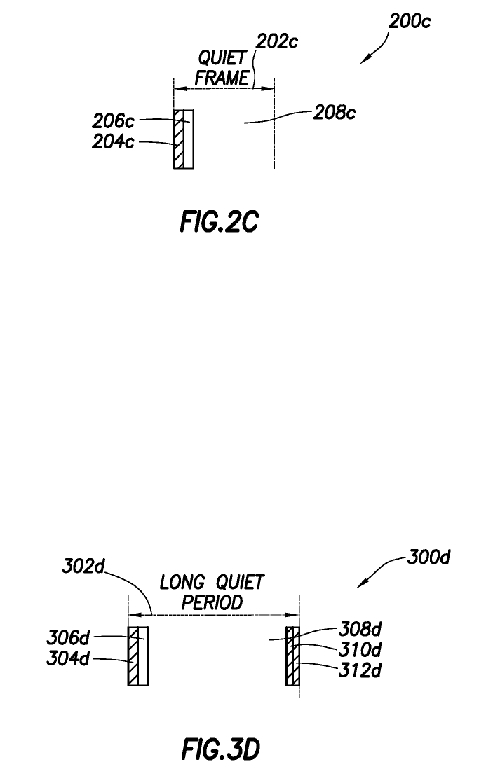

FIGS. 2A, 2B and 2C are related pictorial diagrams depicting a plurality of frame structures 200a, 200b, 200c that can be used for improving frame synchronization and channel estimation in wireless networks, in accordance with one or more example embodiments of the present invention. For example, frame structures 200a, 200b, 200c may be used for frame synchronization and channel estimation in the example system 100 depicted in FIG. 1. For one or more embodiments, the frame structures 200a, 200b, 200c are generated, scheduled and transmitted by a BS (e.g., BS 102), and received and decoded by one or more CPEs (e.g., CPE units 104 through 114).

Referring now to FIG. 2A, for one or more example embodiments, structure 200a may be implemented as a superframe structure in a periodic frame scheduling scheme. In this example, a superframe includes a plurality of frames. The time duration of a superframe can be predetermined and designed to be long enough to achieve a desired high level of spectral efficiency. Also, a superframe can be designed to be short enough to allow the detection of the emergence of incumbent users (i.e., primary users) within a predetermined time period (e.g., defined as 2 seconds in the IEEE 802.22 Functional Requirement Document). Note that although a superframe structure is used for some embodiments, the present invention is not intended to be so limited and other embodiments can be implemented independently of a superframe structure.

In the periodic scheduling scheme depicted in FIG. 2A, exemplary structure 200a includes a superframe 202a, a plurality of “normal” frames 204a and 206a through 206n (where the value of “n” is equal to the number of “normal” frames in the superframe), and a quiet frame 208a. For clarity, in some embodiments, a “normal” frame may be defined as any frame other than a superframe or quiet frame. As shown, in the periodic frame scheduling scheme, the quiet frame 208a is scheduled to occur at a fixed position within the superframe 202a. To demonstrate continuity, the beginning of a second example superframe structure is shown, which includes a plurality of “normal” frames 210a, 212a, and a quiet frame 214a located at the predetermined, fixed position within that superframe. Note that for this illustrative example, each quiet frame in the periodic scheduling scheme is scheduled directly after the first “normal” frame in the superframe. In other embodiments, each quiet frame in a periodic scheduling scheme may be scheduled directly after the second “normal” frame in the superframe (or after the third “normal” frame, fourth “normal” frame, etc.).

For one or more example embodiments, superframe structure 202a includes a superframe header 216a, which (among other functions) indicates the beginning of a superframe. Also, each “normal” frame includes a preamble, Forward Channel (FCH)/MAP signals, and Downlink/Uplink (DL/UL) bursts plus a Transmit/Receive Transition Gap (TTG) and Receive/Transmit Transition Gap (RTG). For this illustrative example, frame 204a includes a preamble 218a, FCH/MAP signals 220a, and DL/UL bursts plus TTG and RTG 222a.

Referring now to FIG. 2B, for one or more example embodiments, structure 200b may be implemented as a superframe structure in an opportunistic frame scheduling scheme. In the opportunistic scheduling scheme depicted in FIG. 2B, exemplary structure 200b includes a superframe 202b, a plurality of “normal” frames 204b, 206b and 208b through 208n (not shown), and at least one quiet frame 210b. As shown, in the opportunistic frame scheduling scheme, the quiet frame 210b can be scheduled to occur at any suitable position within the superframe 202b. Similar to FIG. 2A, to demonstrate continuity, the beginning of a second example superframe structure is shown, which includes a plurality of “normal” frames 212b, 214b, and at least one quiet frame 216b located (opportunistically) at any suitable position within that superframe. Notably, in an opportunistic scheduling scheme, any frame in a superframe can be used as a quiet frame, as long as data is not required to be transmitted in that frame. The length of a quiet frame can be determined by suitably considering the time required to reliably and accurately sense the channel involved. Thus, if one frame in a superframe is inadequate for suitable channel sensing, then a plurality of quiet frames may be scheduled to occur in that superframe.

For one or more example embodiments, superframe structure 202b includes a superframe header 218b, which (among other functions) indicates the beginning of a superframe. Also, each “normal” frame includes a preamble, FCH/MAP signals, and DL/UL bursts plus a TTG and RTG. For this illustrative example, frame 204b includes a preamble 220b, FCH/MAP signals 222b, and DL/UL bursts plus TTG and RTG 224b.

For clarity and ease of understanding, an illustrative quiet frame structure 200c is depicted in FIG. 2C. An exemplary quiet frame 202c is shown, which includes a preamble 204c, FCH/MAP signals 206c, and a dummy broadcast message portion 208c. Alternatively, portion 208c may be a quiet portion without a dummy broadcast message. For example, quiet frame 202c may represent quiet frame 208a or 214a in FIG. 2A, or quiet frame 210b or 216b in FIG. 2B.

Notably, in the example embodiments illustrated by FIGS. 2A and 2B, when a BS schedules a quiet frame to occur (e.g., in a superframe), the BS may transmit the preamble, with or without other dummy broadcast messages including the FCH, DL-MAP and UL-MAP in the first part of the quiet frame. The BS keeps the remainder of the frame “quiet”. In other embodiments, the BS may transmit other broadcast messages after the preamble, and leave the remainder of that frame quiet. Note that the broadcast messages in the quiet frame are dummy messages, because no users are scheduled to receive DL or UL bursts during this period. This broadcast of the dummy messages during this period indicates to the users (e.g., CPEs) that this frame is a quiet frame. Thus, no other control messages are needed to indicate the allocation of quiet frames. However, in a different embodiment, a BS may inform the CPEs about the existence of a quiet frame by including a unique bit (e.g., Quiet Indication bit) in the frame control header, which indicates (by the state of the bit) whether or not the remainder of that frame is quiet. In yet another embodiment, a BS may inform the CPEs about the existence of a quiet frame, in advance or by using a unique type of preamble that includes information to identify that frame as a quiet frame. In that case, there is no need for the dummy messages following the preamble in the quiet frame.

For the periodic and opportunistic scheduling schemes shown in FIGS. 2A and 2B, the users (e.g., CPEs) always receive a preamble within each frame, which provides continuity for their frame synchronization and channel estimation processes. Also, the periodic and opportunistic scheduling schemes shown in FIGS. 2A and 2B provide a relatively straightforward process for the users (e.g., CPEs) to determine whether or not the remainder of a received frame is quiet. For example, the users can determine whether or not a frame is quiet if the users are not scheduled to receive DL or UL bursts, they determine that a Quiet Indication bit is set, or a distinctive preamble indicating a quiet frame is received. A user then knows that the remainder of that frame is quiet, and can sense the in-band channel during that period. Otherwise, the user can follow its normal operations of receiving and/or transmitting data as scheduled.

In addition to allowing a quiet frame to exist (e.g., after a preamble and broadcast message), the periodic and opportunistic scheduling schemes shown in FIGS. 2A and 2B also allow the use of quiet sub-channels and/or quiet sub-carriers. For example, with respect to the use of quiet sub-carriers, a BS may schedule no UL transmission for one or more sub-carriers that are reserved by the BS for channel sensing. Also, for example, the BS may schedule no DL transmission for one or more sub-carriers, and the CPES involved can detect those “white” spaces from the respective DL-MAP messages, and perform channel sensing over the one or more sub-carriers involved.

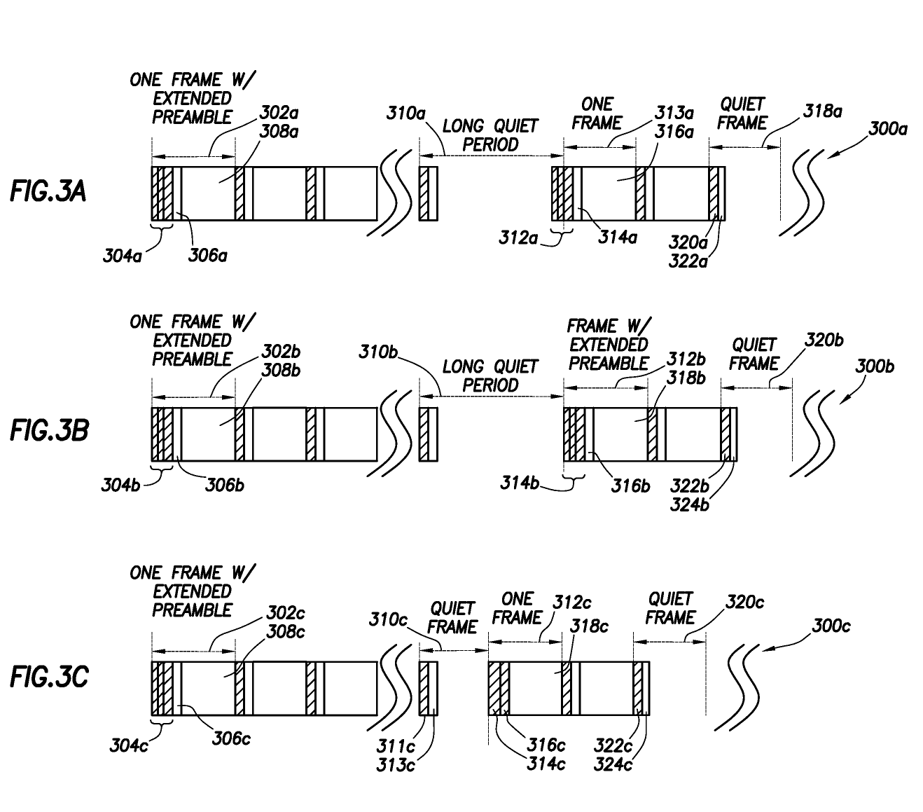

FIGS. 3A through 3D are related pictorial diagrams depicting a plurality of frame structures 300a, 300b, 300c, 300d that can be used for maintaining and/or recovering synchronization after a quiet frame or quiet period in a wireless network, in accordance with one or more example embodiments of the present invention. For example, frame structures 300a, 300b, 300c, 300d may be used for maintaining and/or recovering synchronization after a quiet frame or quiet period in the example system 100 depicted in FIG. 1. For one or more embodiments, the frame structures 300a, 300b, 300c, 300d are generated, scheduled and transmitted by a BS (e.g., BS 102), and received and decoded by one or more CPEs (e.g., CPE units 104 through 114).

Essentially, in accordance with one or more example embodiments of the present invention, when a BS schedules a quiet frame opportunistically, the BS can also transmit (with the quiet frame) a regular preamble along with FCH and empty MAP signals, so that the receiving CPEs can infer that the remainder of the frame is quiet (e.g., opportunistically for channel sensing purposes). The frame scheduled to immediately follow the empty frame can include an extended preamble. Note that this specific scheduling is only due to a design limitation, and not intended to limit the scope of the invention. In other words, as a practical matter, too much overhead may be expended if an extended preamble is required to be scheduled after every quiet frame involved.

Additionally, when a BS schedules a quiet period (e.g., time period greater than that of one quiet frame) periodically or in advance, one of the following methods may be used. A regular preamble can be scheduled to occur at the beginning of the first quiet frame. An extended preamble can be scheduled to occur at two symbols prior to the end of the last quiet frame, which maintains the spectral efficiency of the next frame. An extended preamble can be scheduled to occur right after the end of a quiet period. In any event, after a relatively long quiet period, the embodiments provide approaches whereby a regular preamble and an extended preamble including both a regular training sequence and a long training sequence can be transmitted, in order to assist the CPEs with synchronization.

Specifically, referring to FIG. 3A for one or more example embodiments, the exemplary frame structure 300a shows (at the beginning) a frame 302a including an extended preamble 304a, FCH/MAP signals 306a, and DL/UL bursts, TTG, RTG 308a. A long quiet period 310a is also included, and an extended preamble 312a in a regular frame 313a is scheduled to occur at two symbols prior to the end of the long quiet period 310a. The regular frame 313a also includes FCH/MAP signals 314a, and DL/UL bursts, TTG, RTG 316a. Frame structure 300a also includes a quiet frame 318a scheduled opportunistically in this example. The quiet frame 318a includes a regular preamble 320a and FCH/(empty)MAP signals 322a.

Referring to FIG. 3B for one or more example embodiments, the exemplary frame structure 300b shows (at the beginning) a frame 302b including an extended preamble 304b, FCH/MAP signals 306b, and DL/UL bursts, TTG, RTG 308b. A long quiet period 310b is also included, but (different that FIG. 3A) an extended preamble 314b in a regular frame 312b is scheduled to occur at the end of the long quiet period 310b. The regular frame 312b also includes FCH/MAP signals 316b, and DL/UL bursts, TTG, RTG 318b. Frame structure 300b also includes a quiet frame 320b scheduled opportunistically in this example. The quiet frame 320b includes a regular preamble 322b and FCH/(empty)MAP signals 324b.

Referring to FIG. 3C for one or more example embodiments, the exemplary frame structure 300c shows (at the beginning) a frame 302c including an extended preamble 304c, FCH/MAP signals 306c, and DL/UL bursts, TTG, RTG 308c. Frame structure 300c also includes a quiet frame 310c scheduled in advance in this example. The quiet frame 310c includes a regular preamble 311c and FCH/(empty)MAP signals 313c. A regular frame 312c is also scheduled, which includes a regular preamble 314c, FCH/MAP signals 316c, and DL/UL bursts, TTG, RTG 318c. A quiet frame 320c is scheduled (in advance in this example), which includes a regular preamble 322c and FCH/(empty)MAP signals 324c. Note that the format used for exemplary frame structure 300a in FIG. 3A can be used at the same time as either one of the other frame structures 300b, 300c in FIGS. 3B and 3C.

For clarity and ease of understanding, an illustrative long quiet period or frame structure 300d is depicted in FIG. 3D. An exemplary long quiet period or frame 302d is shown, which includes a regular preamble 304d, FCH/MAP signals 306d, and a long quiet period 308d. Note that two portions 310d, 312d of an extended preamble are scheduled to occur at two symbols prior to the end of the long quiet period 308d. For example, the long quiet period or frame 302d may represent the long quiet period or frame structure 310a shown in FIG. 3A.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A method for improving frame synchronization and channel estimation in a wireless network, comprising the steps of:
generating a first preamble for a frame;
generating a false control message for the frame; and
scheduling a quiet interval for the frame.

2. The method of claim 1, further comprising the step of:
transmitting the first preamble, false control message, and scheduled quiet interval as a quiet frame.

3. The method of claim 1, wherein the false control message is a dummy broadcast message.

4. The method of claim 1, wherein the first preamble includes information that identifies the frame as a quiet frame.

5. The method of claim 1, wherein a portion of the frame includes a quiet indication bit.

6. The method of claim 1, wherein the generating and scheduling steps are performed by a processing unit associated with a Base Station in the wireless network.

7. The method of claim 1, further comprising the steps of:
generating a superframe header;
generating a non-quiet frame;
appending the non-quiet frame to the superframe header;
transmitting the superframe header and the non-quiet frame; and
transmitting the first preamble, false control message, and scheduled quiet interval as a quiet frame.

8. A method for improving frame synchronization and channel estimation in a wireless network, comprising the steps of:
generating a superframe;
inserting at least one frame in the superframe;
inserting a second frame in the superframe, the second frame including a preamble, a dummy broadcast message, and a quiet interval; and
transmitting the superframe.

9. The method of claim 8, wherein the quiet interval comprises at least one of a quiet sub-channel and a quiet sub-carrier.

10. The method of claim 8, further comprising the step of:
listening for a channel during the quiet interval.

11. The method of claim 8, wherein the steps are performed by a Base Station in a Cognitive Radio-based network.

12. The method of claim 8, wherein the second frame is scheduled periodically in a plurality of superframes.

13. The method of claim 8, wherein the second frame is scheduled opportunistically in a plurality of superframes.

14. A method for maintaining or recovering synchronization in a wireless network, comprising the steps of:
generating a first frame;
determining if the first frame is a quiet frame;
if the first frame is a quiet frame, inserting an extended preamble in a second frame; and
transmitting the second frame two symbols prior to the end of the first frame.

15. A method for maintaining or recovering synchronization in a wireless network, comprising the steps of:
determining if a quiet transmission period is occurring; and
if a quiet transmission period is occurring, generating a frame, inserting an extended preamble in the frame, and transmitting the frame.

16. The method of claim 15, wherein the transmitting step further comprises transmitting the frame two symbols prior to the end of the quiet transmission period.

17. The method of claim 15, wherein the length of the quiet transmission period is greater than the length of a quiet frame.

18. A system for improving frame synchronization and channel estimation in a wireless network, comprising:
a base station; and
at least one user transceiver coupled to the base station by a radio air interface, the base station configured to:
generate a first preamble for a frame;
generate a false control message for the frame; and
schedule a quiet interval for the frame.

19. A system for improving frame synchronization and channel estimation in a wireless network, comprising:
a base station; and
at least one user transceiver coupled to the base station by a radio air interface, the base station configured to:
generate a superframe;
insert at least one frame in the superframe;
insert a second frame in the superframe, the second frame including a preamble, a dummy broadcast message, and a quiet interval; and
transmit the superframe.

20. A system for maintaining or recovering synchronization in a wireless network, comprising:
a base station; and
at least one user transceiver coupled to the base station by a radio air interface, the base station configured to:
generate a first frame;
determine if the first frame is a quiet frame;
if the first frame is a quiet frame, insert an extended preamble in a second frame; and
transmit the second frame two symbols prior to the end of the first frame.

21. A system for maintaining or recovering synchronization in a wireless network, comprising:
a base station; and
at least one user transceiver coupled to the base station by a radio air interface, the base station configured to:
determine if a quiet transmission period is occurring; and
if a quiet transmission period is occurring, generate a frame, insert an extended preamble in the frame, and transmit the frame.

22. The system of claim 21, wherein the base station is further configured to:
if a quiet transmission period is occurring, transmit the frame two symbols prior to the end of the quiet transmission period.
